(19) United States
(12) Patent Application Publication
(10) Pub. No.: US 2016/0356404 A1
(43) Pub. Date: Dec. 8, 2016

(54) Mini-Split Connection Box

(71) Applicants: Robert Roy Panek, SR., Farmington, NH (US); Shaun Brouillard, Farmington, NH (US)

(72) Inventors: Robert Roy Panek, SR., Farmington, NH (US); Shaun Brouillard, Farmington, NH (US)

(73) Assignee: Robert Roy Panek, SR., Farmington, NH (US)

(21) Appl. No.: 14/833,121

(22) Filed: Aug. 23, 2015

Related U.S. Application Data
(60) Provisional application No. 62/170,585, filed on Jun. 3, 2015.

(51) Int. Cl. F16L 5/00; F16L 3/22; F16L 3/08

(52) U.S. Cl. CPC F16L 5/00; F16L 3/08; F16L 3/22

(57) ABSTRACT

Mini Split Ductless Connection Boxes can be constructed so as to be useful in housing all of the mini split-ductless lines, electrical and drainage plumbing in the space between the wall studs that connect the outdoor unit to the indoor unit.

### BACKGROUND OF THE INVENTION

A mini split is a ductless heating system, cooling system or both. It has two main parts to the system an outdoor unit and indoor unit. The outdoor unit has a line set consisting of refrigeration lines, electrical lines and drainage line also known as a line set. This line set can be fed from the outdoor unit through the space in a wall between two studs. This line set installation occurs during construction when the drywall is not attached exposing the bare studs. When the drywall installers install the drywall the line set will often be covered by the drywall. Once the line set is covered by drywall the mini split ductless installer has to try to locate the line set at a later date. This will often cause mistakes in locating the line sets requiring drywall repair work to be done. Once the mini split ductless installer locates the lines they need to cut a hole in the drywall. When the hole is cut they work in a very narrow area with tools that could damage the surrounding drywall.

The invention set forth in this specification pertains to new mini split ductless connection box. This box is especially desirable because it will house all the connection lines from the outdoor unit of a mini split ductless system. The connection box is generic enough to accommodate mini split ductless systems from most mini split ductless manufactures. These lines coming from the outdoor unit will include an electrical line, drain line, and refrigeration line set and any other plumbing needed to make a connection between the outside unit and the inside unit. This collection of lines is called a line set. The line set will be fed through any of the knockouts located on the top or bottom on the connection box. A downwardly extending drain on the bottom of the connection box will allow for a connection to a drain tube. This connection box will show the drywall installers they need to cut a hole in the drywall for the connection box as they would for any other junction type box used in electrical or plumbing. The additional connection box frame will then cover the rough drywall edges around the connection box for an aesthetically pleasing finish.

### BRIEF SUMMARY OF THE INVENTION

This new mini split ductless connection box will be placed between the wall studs during the line set installation. The line installers will mount the connection box to the bare wall studs. The line installers will then feed the lines from the outdoor unit through the knockouts on the connection box. A drain pipe or tube will be connected to the downwardly extending drain neck. The drywall installers can now see where they need to create a cutout in the drywall for the mini split ductless connection box. When the mini split ductless installers return to install the mini split ductless indoor unit, they will see the connection box and plumbing ready to do the final connection to the indoor unit.

### BRIEF DESCRIPTION OF THE DRAWINGS

FIG. 1 is a front elevation view of a presently preferred embodiment of a Mini Split Ductless Connection Box in accordance with this invention, studs such as this box is adapted to fit between being illustrated in this view in phantom,

FIG. 2 is a side elevation and depth view of this box,

FIG. 3 is a top depth view of this box,

FIG. 4 is bottom depth view of this box,

FIG. 5 is the front elevation of the connection box frame,

FIG. 6 is a side elevation and depth view of the frame. The frame is adapted to cover the rough cut drywall shown in phantom.

The mini split ductless connection box illustrated in the drawing is two pieces constructed so as to utilize the operative, essentially intangible concepts or principles of the invention set forth and defined in the appended claims.

### DETAILED DESCRIPTION OF THE PREFERRED EMBODIMENT

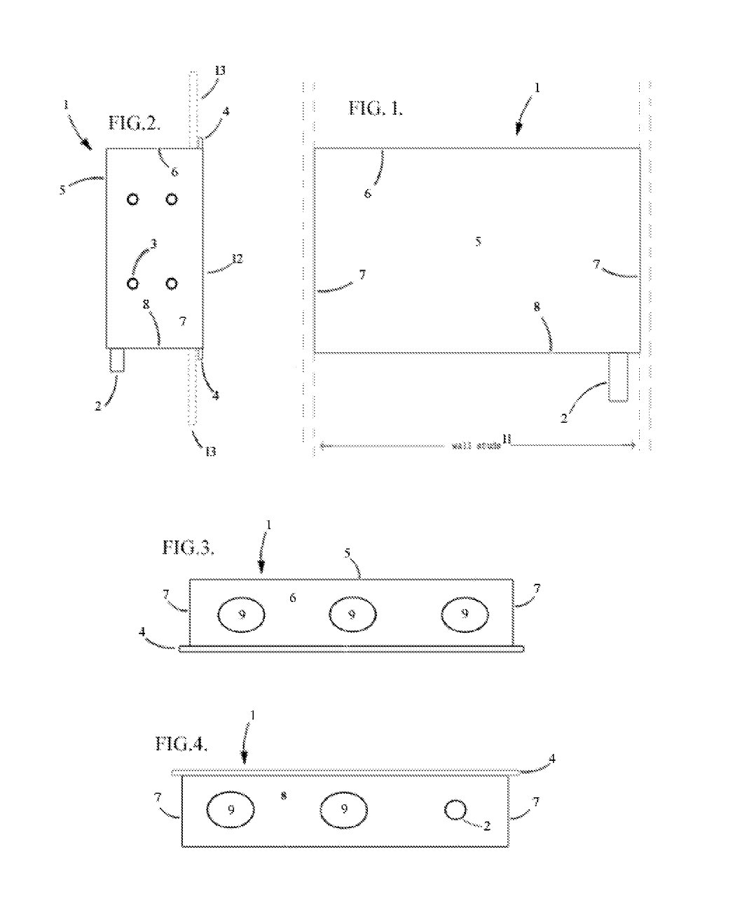

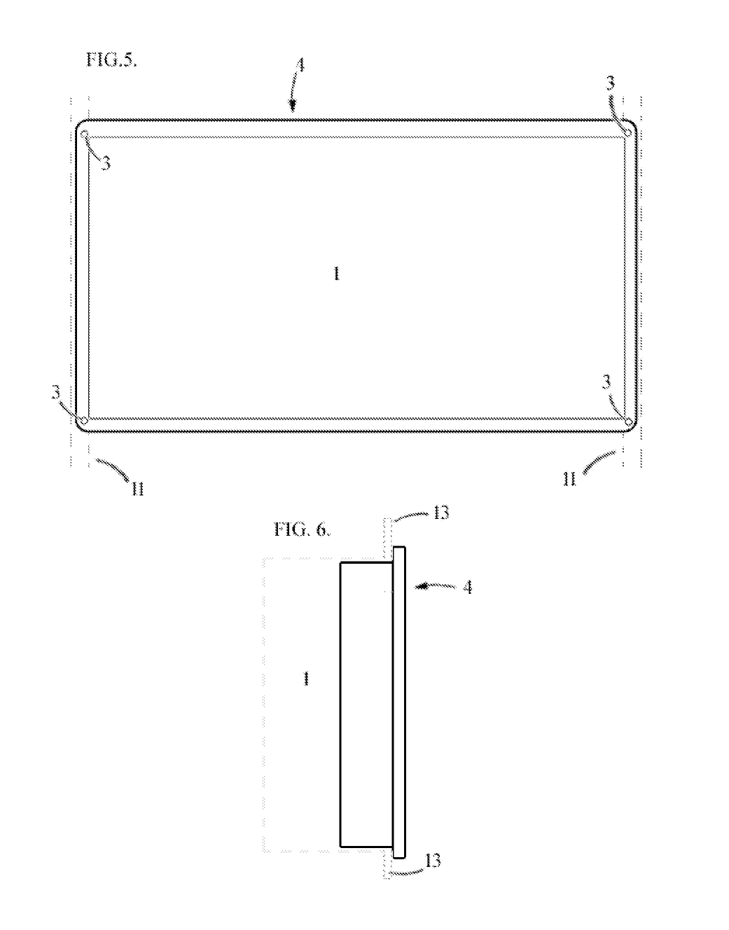

In the drawing, there is shown a mini split ductless connection box 1 which is preferably formed as a unitary, watertight box out of a known polymer or plastic material. This box is of a generally rectangular shape and includes a bottom 8, a top 6 which is parallel to the bottom 8, sides 7 connecting the top and bottom 6 and 8, and a back 5 connecting the bottom 6, the top 8 and the sides 7. Four mounting holes 3 are located on the each side 7 for use in mounting the box 1 on and between conventional studs 11 as shown in phantom in FIG. 1.

Knockouts 9 are provided on the top 6 and bottom 8 to provide holes to run the line set and electrical wires through. A downwardly extending drain neck 2 extends from the bottom 8 of the box 1 will allow a standard ¾ inch drain hose to be connected. Because of the versatility of the box 1 a knockout 9 can be removed to alternately accommodate a drain line (not shown) regardless of where such a drain line is located and if it is not compatible the downwardly extending drain neck 2.

The outside frame 4 used for appearance reasons and mounting holes 3 will extend over the rough cut drywall 13. The four mounting holes 3 on the frame 4 will allow for drywall screws to secure the frame 4 to the drywall 13 giving the connection box 1 a professionally looking finish.

I claim:

1. A mini split ductless connection box having a rectangular shape including a top, back and sides and open in the front. Said box to be mounted in the space between wall studs. The said box to contain knockouts to feed in electrical lines, and refrigeration lines from a mini split ductless outside unit. The connection box will house the line sets that will be connected to the inside unit. The said box will have a drain hole on bottom with a downwardly extending neck of said box to provide drainage. The said box will have a second piece for framing the box covering the rough cut drywall.
